(19) United States
(12) Patent Application Publication
(10) Pub. No.: US 2010/0068427 A1
(43) Pub. Date: Mar. 18, 2010

(54) CAST-COATING-LIKE INKJET PRINTING MATERIAL

(75) Inventors: Andre Becker, Kreuzau (DE); David Croll, Odenthal (DE); Dominik Fuchs, Koln (DE); Friedhelm Halfenberg, Julich (DE)

Correspondence Address: KNOBBE MARTENS OLSON & BEAR LLP, 2040 MAIN STREET, FOURTEENTH FLOOR, IRVINE, CA, 92614, US

(73) Assignee: M-real Oyj, Espoo (FI)

(21) Appl. No.: 12/438,343

(22) PCT Filed: Aug. 10, 2007
(86) PCT No.: PCT/EP07/07088

§ 371 Date: Oct. 12, 2009

(30) Foreign Application Priority Data
Aug. 22, 2006 (EP) 06017408.3

(51) Int. Cl. B41M 5/52; B41M 5/50; B05D 1/36; B05D 3/12; B05D 5/04

(52) U.S. Cl. 428/32.31; 428/32.35; 427/419.2; 427/365; 427/361

(57) ABSTRACT

The present invention relates to an inkjet recording material comprising:
a) a substrate
b) at least one ink-accepting layer applied to at least one side of the substrate, containing at least one pigment selected from the group consisting of calcium carbonate, calcined clay, satin white or mixtures thereof, the mean particle size of the pigment being from 0.1 μm to 1.5 μm,
c) at least one surface layer applied to the at least one ink-accepting layer, the surface layer containing cationic inorganic particles,
   the inkjet recording material having a gloss in the range from 10 to 60, measured according to DIN 54502 R′ (45°) (measuring angle 45°), on the side to which the at least one surface layer was applied, and the density of the inkjet recording material being greater than or equal to 0.95 g/cm³, and to a process for its production.

The present invention relates to an inkjet recording material having improved properties, and to a process for the production thereof.

In order to produce high-resolution prints using inkjet printers, it is firstly necessary for the printer used to have a correspondingly high resolution in order to have the capability of producing brilliant prints. Secondly, such brilliant prints can be produced only on papers which have an appropriate finish or coating for this purpose. In order to produce high-quality colored prints on papers, it has become established on the one hand to use PE-based papers where an acceptor layer which fixes the ink applied during printing was applied to the polyethylene layer (PE layer). Another possibility for producing paper for high-quality prints is the use of so-called “cast-coated inkjet papers”. In the case of the cast-coated inkjet papers, the surface structure of a surface as smooth as glass, such as, for example, that of a chromium cylinder polished to a high gloss, is transferred to the surface of the inkjet recording material. Such papers are distinguished in that they have very great smoothness. A disadvantage of this process, however, is that the cast-coating process is a very expensive process. The reason for this is firstly a very expensive cast-coating cylinder which has to be cleaned at regular intervals in order to remove dirt from its surface, which dirt leads to a disadvantageous surface of the cast-coated paper produced. Secondly, as a result of the system, the speeds with which papers can be produced are only very low. This is because water vapor has to be transported through the ink-accepting layer and the paper substrate during the transfer of the surface of the chromium cylinder to the inkjet recording material.

An inkjet recording material produced in this manner is disclosed, for example, in WO 2002/072359. The inkjet recording material described is distinguished in that the surface layer has a gloss in the range from 5 to 35, measured according to DIN 54502 R′ (75° C.) (measuring angle 75°) and a surface smoothness of less than 2.5 μm according to the Parker Print Surf method (PPS) based on DIN ISO 8791-4.

As a result of the cast-coating process, this paper and all further cast-coated papers have a density of less than 0.9 g/cm³. This is due to the cast-coating process since only low pressures are used during the production of the coated papers. In contrast, papers which were subjected to calendering have a substantially higher density.

With the knowledge of the prior art, there is therefore a need to provide inkjet recording materials which have the advantages of the cast-coated inkjet recording materials with respect to the printability but can be more economically produced. In particular, such papers are also to be produced on units which permit higher production speeds than is the case with cast-coating processes.

The technical object of the present invention is to provide an inkjet recording material which has very good printability which is comparable with cast-coated papers, while in addition the drying time of an ink applied during printing is very short so that smearing of the print because the ink has not dried is prevented. The present invention furthermore relates to the provision of a process for the production of an improved inkjet recording material.

The technical object of the present invention is achieved by an inkjet recording material comprising:

Inkjet recording material comprising:
a) a substrate
b) at least one ink-accepting layer applied to at least one side of the substrate, containing at least one pigment selected from the group consisting of calcium carbonate, calcined clay, satin white or mixtures thereof, the mean particle size of the pigment being from 0.1 μm to 1.5 μm,
c) at least one surface layer applied to the at least one ink-accepting layer, the surface layer containing cationic inorganic particles,
   the inkjet recording material having a gloss in the range from 10 to 60, measured according to DIN 54502 R′ (45°) (measuring angle 45°), on the side to which the at least one surface layer was applied, and the density of the inkjet recording material being greater than or equal to 0.95 g/cm².

The density of the inkjet recording material can be determined according to DIN ISO 534.

In a preferred embodiment, the substrate is a paper or cardboard. The substrate preferably has a basis weight (absolutely dry) of from 40 g/m² to 350 g/m².

The pigment in the ink-accepting layer preferably has a mean particle size of from 90 to 250 nm, more preferably from 150 nm to 250 nm and most preferably from 190 to 250 nm.

It is preferable if the pigment in the ink-accepting layer (b) is a cationic or anionic pigment. A preferred pigment is calcium carbonate, in particular precipitated calcium carbonate (PCC) and/or a ground calcium carbonate (GCC).

The ink-accepting layer (b) preferably contains from 65 to 95% by weight (absolutely dry) of the pigment. More preferably, the ink-accepting layer (b) contains from 75 to 95% by weight and even more preferably from 80 to 95% by weight of the pigment.

The ink-accepting layer (b) can preferably contain a binder. Suitable binders are water-soluble resins, such as, for example, polyvinyl alcohol, starch, cationized starch, casein, gelatin, acrylic resins, urethane resins, sodium alginate, polyvinylpyrrolidone, carboxymethylcellulose and hydroxyethylcellulose. Furthermore, lattices, acrylic polymers, such as, for example, polymers of acrylates or methacrylates and copolymers of these monomers with other monomers, lattices of carboxyl-modified conjugated diene copolymers and lattices of vinyl copolymers, such as, for example, ethylene/vinyl acetate copolymers, can furthermore be used. These binders can be used either individually or in combination.

In a preferred embodiment, the ink-accepting layer (b) contains from 5 to 35% by weight of the binder, more preferably from 10 to 30% by weight and most preferably from 15 to 25% by weight of the binder.

The ink-accepting layer (b) preferably has a coat weight (absolutely dry) of from 5 to 30 g/m². The term “absolutely dry” is understood as meaning drying of the inkjet recording material to constant weight. This is usually effected at a temperature of from 105 to 110° C. The coat weight, which is then measured on the inkjet recording material, corresponds to the absolutely dry coat weight.

The ink-accepting layer (b) can also be applied several times to the substrate. It is preferable if 2, 3, 4, 5 or 6 ink-accepting layers are applied to the substrate.

The respective ink-accepting layers may have the same or a different composition, provided that they are within the definition of the ink-accepting layer (b).

It is furthermore preferable if the at least one ink-accepting layer (b) and/or the at least one surface layer (c) contains a cationic compound which is not a pigment. The cationic compound can preferably be selected from polyallylamine and the quaternary salts thereof, polyamine sulfone and the quaternary salts thereof, polyvinylamine and the quaternary salts thereof, chitosans and the acetates thereof, polymers of monomers selected from the group consisting of dimethylaminoethyl (meth) acrylate, diethylaminoethyl (meth)acrylate, methylethylaminoethyl (meth)acrylate, dimethylaminostyrene, diethylaminostyrene, copolymers of vinylpyrrolidone with a quaternary salt of an aminoalkyl (meth)acrylate and a copolymer of (meth)acrylamide with a quaternary salt of aminomethyl (meth) acrylamide.

Cationic inorganic particles of the surface layer (c) are preferably selected from alumina, aluminum hydroxide, hydrated alumina, silica whose surface was cationized, aluminum silicates or other metalloid oxides. Particles which may also be used are those referred to as “cationic inorganic pigment” in US 20030219553, in particular the pigments mentioned there in paragraphs [0036] to [0042]. The abovementioned inorganic particles may be present either individually or as a mixture in the surface layer (c).

The cationic inorganic particles of the surface layer (c) can have a mean particle diameter in the range from 1 to 1000 nm, preferably from 50 to 500 nm. Preferably, the surface layer (c) additionally contains organic pigments comprising a thermoplastic resin. The surface layer (c) preferably has a coat weight (absolutely dry) of from 2 to 15 g/m². More preferably, the coat weight of the surface layer (c) is from 3 to 13 g/m² and particularly preferably from 2.5 to 10 g/m². The coat weight of the surface layer (c) can be determined according to the method for determining the coat weight of the ink-accepting layer (b).

The surface layer (c) can preferably contain a binder. Suitable binders are water-soluble resins, such as, for example, polyvinyl alcohol, starch, cationized starch, casein, gelatin, acrylic resins, urethane resins, sodium alginate, polyvinylpyrrolidone, carboxymethylcellulose and hydroxyethylcellulose. Furthermore, lattices, acrylic polymers, such as, for example, polymers of acrylates or methacrylates and copolymers of these monomers with other monomers, lattices of carboxyl-modified conjugated diene copolymers and lattices of vinylcopolymers, such as, for example, ethylene/vinyl acetate copolymers, can be used. These binders can be used either individually or in combination.

In a preferred embodiment, the surface layer (c) contains from 5 to 35% by weight of the binder, more preferably from 10 to 30% by weight and most preferably from 15 to 25% by weight.

Further additives may be present both in the ink-accepting layer (b) and in the surface layer (c).

Suitable such additives are, for example, thickeners, optical brighteners, rheology modifiers, surfactants, further pigments or fillers.

Advantageously, the at least one ink-accepting layer and/or the at least one surface layer is applied to both sides of the substrate.

The gloss of the inkjet recording material is preferably from 10 to 50, more preferably from 20 to 50, measured according to DIN 54502 R′ (45°) (measuring angle 45°).

The density of the inkjet recording material is preferably ≧1.00 g/m² and more preferably ≧1.10 g/m², according to DIN ISO 534.

The inkjet recording material according to the present invention has a very short drying time which is in the region of the drying times of cast-coated papers. An applied inkjet print dries very rapidly, so that possible smearing of the dried-on print is reliably prevented. Moreover, the inkjet recording material has outstanding printability. The bleeding and fading of an applied print is very low so that brilliant prints having very crisp contours can be applied to the inkjet recording material according to the invention.

Advantageously, the inkjet recording material of the present invention also leads to an improvement in the running property in inkjet printers. Any interruptions or multipicks during the printing are very substantially avoided. This advantage plays an important role in particular in the case of relatively high basis weights since, in spite of a high basis weight, unexpectedly no impairment of the printing process occurs, as takes place more frequently with high-weight cast-coated papers.

The present invention furthermore relates to a process for the production of an inkjet recording material, comprising the steps:
a) provision of a substrate,
b) application of at least one ink-accepting layer to at least one side of the substrate, containing at least one pigment selected from the group consisting of calcium carbonate, calcined clay, satin white or mixtures thereof, the mean particle size of the pigment being from 0.1 μm to 1.5 μm,
c) application of at least one surface layer to the at least one ink-accepting layer, the surface layer containing cationic inorganic particles, and
d) optional calendering of the inkjet recording material.

The substrate used in step a) is preferably a paper or cardboard. The ink-accepting layer in step b) and/or the surface layer in step c) is preferably applied from an aqueous coating slip. Any coating unit which is familiar to the person skilled in the art can in principle be used for this purpose. In particular, the use of a blade coater, an airbrush, a knife coater, an air knife, a slot nozzle and/or a curtain coater is preferred for applying the ink-accepting layer in step b) and/or the surface layer in step c).

As already mentioned, a plurality of ink-accepting layers and/or surface layers may be present in the inkjet recording material according to the invention. If such an inkjet recording material is produced, the individual layers are each applied individually, as described further above.

It is particularly preferable if a blade coater is used for applying the ink-accepting layer and if a curtain coater, a slot nozzle or a blade coater is used for applying the surface layer.

It is preferable if the inkjet recording material is calendered after application of the surface layer. In the context of this invention, the term “calendering” is understood as meaning any method which smooths the surface of the inkjet recording material by means of pressure and/or temperature. In particular, the calendering with the aid of a calender is preferred. All calenders which are customary, for example, for the production of offset papers can be used for this purpose. These calenders usually have 12 rolls through which the paper to be calendered is fed and is smoothed under high pressure. Depending on the calendering conditions, the paper is compressed so that the density of the paper prior to feeding into the calender is lower than after emergence from the calender.

It has been found that the use of the formulations usually used for the production of cast-coated papers does not lead to the desired result in the process according to the invention since the smoothness of the inkjet recording material thus obtained is then insufficient. Where a greater smoothness was achieved, the printability of such a paper of the prior art is insufficient.

On the other hand, it is found that the process of the present invention surprisingly gives inkjet recording materials which have a printability comparable with the cast-coated papers of the prior art and an outstanding gloss. In comparison with inkjet papers which have a polyethylene coating, it is also surprisingly found that the papers of the present invention have a back, i.e. the side on which the surface layer was not applied, which is comparable with PE papers. Thus, by feeling the back (haptic properties of the back), a potential customer is not immediately able to determine that the papers of the present invention are not so-called polyethylene papers. The papers according to the invention furthermore have the advantage that polyethylene need no longer be removed when recycling the papers of the present invention.

The present invention is illustrated by the following examples.

The proportions of the ingredients in the coating slips are stated in per cent by weight after drying of the coating slip (absolutely dry). A proportion of water which makes the coating slips processable is additionally present in the coating slips prior to application to the coating paper. After application of the coating slip to the coating paper, this proportion of water is removed by drying.

### EXAMPLE 1

A standard base paper having a basis weight of 150 g/m² is precoated on one side by means of a blade coater with 15 g/m² (absolutely dry) of a coating slip, prepared according to formulation 1 in table 1, and is dried. A coating slip prepared according to formulation 1 from table 2 is now applied in an amount of 10 g/m² (absolutely dry) using a curtain coater. The web speed is about 150 m/min.

Drying is effected at 130-200° C. The paper is then calendered using a calender.

### EXAMPLE 2

A standard base paper having a basis weight of 140 g/m² is precoated on one side by means of a blade coater with 15 g/m² (absolutely dry) of a coating slip, prepared according to formulation 2 in table 1, and is dried. A second preliminary coat is applied with the same slip in an amount of 20 g/m² (absolutely dry) by means of a curtain coater and is dried.

A coating slip prepared according to formulation 2 from table 2 is now applied in an amount of 12 g/m² (absolutely dry) by means of a curtain coater and is dried. The web speed is about 150 m/min.

Drying is effected at 130-200° C. The paper is then calendered using a calender.

TABLE 1
(% by weight data in absolutely dry coat/coating slip)

| Formulation 1 | Formulation 2 |
|---|---|
| Calcium carbonate¹⁾ 90% | Calcium carbonate¹⁾ 80% |
| by weight | by weight |
| PVA - 9.5% by weight | Satin white²⁾ - 10% by weight |
| Thickener - 0.5% by weight | Latex binder - 9% by weight |
| | Thickener - 1% by weight |

¹⁾Covercarb 85, mean particle size 0.5 μm
²⁾Mean particle size 1-2 μm
³⁾Opacarb 40, mean particle size 0.4 μm
⁴⁾Jetcoat 30, mean particle size 0.1-1.0 μm

TABLE 2
(% by weight data in absolutely dry coating slip)

| Formulation 1 | Formulation 2 |
|---|---|
| Cationizing agent - 1.5% by weight | Cationizing agent - 1% by weight |
| Silica¹⁾ - 88% by weight | Silica¹⁾ - 83.5% by weight |
| Latex binder - 10% by weight | PVA - 10% by weight |
| Surfactant - 0.5% by weight | Plasticizer - 5% by weight |
| | Surfactant - 0.5% by weight |
| Water to 41% by weight | Water to 39% by weight |

¹⁾Mean particle size 100-250 nm

The properties of the inkjet recording materials according to the invention are shown in table 3. The method of measurement used in each case is stated in the 1^{st} column.

TABLE 3

| | | | Comparison |
|---|---|---|---|
| | Example 1 | Example 2 | (cast-coated) |
| Basis weight [g/m²] | 175.6 | 185.1 | 182.1 |
| Density [g/cm³] | 1.195 | 1.129 | 0.795 |
| ISO 534 | | | |
| Thickness [mm] | 0.147 | 0.164 | 0.229 |
| Gloss 45°/75° | 33.6/61.2 | 35.1/63.1 | 29.5/62.5 |
| DIN 54502 R′ (45°) or R′ | | | |
| (75°) | | | |
| Whiteness R457 without SP | 86.08 | 84.33 | 88.31 |
| filter, top [%] | | | |
| DIN 53145/ISO 2470 | | | |
| Brightness, top | 11.60 | 10.67 | 19.19 |
| DIN 53145/ISO 2470 | | | |
| L*, top | 93.30 | 92.97 | 95.73 |
| ISO 11475 | | | |
| a* top | −0.14 | −0.10 | 3.47 |
| ISO 11475 | | | |
| b* top | −8.41 | −9.15 | −13.03 |
| ISO 11475 | | | |
| Opacity [%] | 97.44 | 98.77 | 99.01 |
| DIN 53146/ISO 2471 | | | |
| Roughness top/back | 0.84/24 | 1.24/56 | 1.54/54 |
| [PPS]/[BENDTSEN.] | | | |
| DIN ISO 8791-4 or | | | |
| ISO 8791-2, DIN 53108 | | | |

Table 4 below once again summarizes the papers produced according to the invention and their structure:

TABLE 4

| | Example 1 | Example 2 |
|---|---|---|
| Substrate | Base paper | Base paper |
| Coating | One side | One side |
| Basis weight g/m² | 150 | 140 |
| Total coat g/m² | 25 | 47 |
| Basis weight, | 175 | 187 |
| finished g/m² | | |
| Precoat 1/sides g/m² | 15/0 | 15/0 |
| Precoat 2/sides g/m² | — | 20/0 |
| Top coat/sides g/m² | 10/0 | 12/0 |
| Coat/sides g/m² | 25/0 | 47/0 |
| Formulations for | | |
| Precoat 1 | 1 from tab. 1 | 2 from tab. 1 |
| Precoat 2 | — | 2 from tab. 1 |
| Top coat | 1 from tab. 2 | 2 from tab. 2 |
| Coating unit for | | |
| Precoat 1 | Blade | Blade |
| Precoat 2 | — | Curtain |
| Top coat | Curtain | Curtain |
| Substances in | | |
| Precoat 1 | 90 Covercarb | 80 Covercarb |
| (all in % by weight | 9.5 PVA | 10 satin white |
| absolutely dry) | 0.5 thickener | 9.0 latex binder |
| | | 1.0 thickener |
| Substances in | | |
| Precoat 2 | | 80 Covercarb |
| (all in % by weight | | 10 satin white |
| absolutely dry) | | 9.0 latex binder |
| | | 1.0 thickener |
| Substances in | | |
| Top coat | (Water to 41%) | (Water to 39%) |
| (all in % by weight | 1.5 cationizing agent | 1.0 cationizing agent |
| absolutely dry) | 88.0 silica | 83.5 silica |
| | 10.0 polymer latex binder | 10.0 PVA |
| | 0.5 surfactant | 5.0 plasticizer |
| | | 0.5 surfactant |
| Web speed m/min | 150 | 150 |
| Drying ° C. | 130-200 | 130-200 |

### Description of the Printability:

The paper shows very good printability (soluble inks) on all customary inkjet printer types (e.g. Hewlett Packard, Epson, Canon, Lexmark). With pigmented inks, too, very good printability is present.

Both the crispness of edges and the ink densities are very good. Printed areas show no mottling or only very slight mottling (spotted appearance of the print) with all printers and inks.

Running together of colors or ink repulsion does not take place with any ink or color mix. The inks are dry immediately after the end of printing.

### Gloss:

The gloss which has resulted here has a somewhat lower measured value than, for example, a cast-coated paper.

The visually perceived gloss is, however, at least at the same level.

The effect occurring here is a sort of “behind glass effect” in which the gloss is produced in the precoat by the calendering. The top coat, which becomes transparent as a result of calendering, shows firstly the gloss of the precoat and reinforces this by its own gloss.

1. An inkjet recording material comprising:
a) a substrate
b) at least one ink-accepting layer applied to at least one side of the substrate, containing at least one pigment selected from the group consisting of calcium carbonate, calcined clay, satin white or mixtures thereof, the mean particle size of the pigment being from 0.1 μm to 1.5 μm,
c) at least one surface layer applied to the at least one ink-accepting layer, the surface layer containing cationic inorganic particles,
wherein the inkjet recording material having a gloss in the range from 10 to 60, measured according to DIN 54502 R′ (45°) (measuring angle 45°), on the side to which the at least one surface layer was applied, and the density of the inkjet recording material being greater than or equal to 0.95 g/cm³.

2. The inkjet recording material as claimed in claim 1, characterized in that the substrate is a paper or cardboard.

3. The inkjet recording material as claimed in claim 1, characterized in that the pigment in the ink-accepting layer b) is a cationic or anionic pigment.

4. The inkjet recording material as claimed in claim 1, characterized in that the ink-accepting layer b) contains from 65 to 95% by weight (absolutely dry) of the pigment.

5. The inkjet recording material as claimed in claim 1, characterized in that the ink-accepting layer b) contains from 5 to 35% by weight of a binder.

6. The inkjet recording material as claimed in claim 1, characterized in that the ink-accepting layer b) has a coat weight (absolutely dry) of from 5 to 30 g/m².

7. The inkjet recording material as claimed in claim 1, characterized in that the at least one ink-accepting layer b) and/or the at least one surface layer c) contains a cationic compound which is not a pigment.

8. The inkjet recording material as claimed in claim 7, characterized in that the cationic compound is selected from polyallylamine and the quaternary salts thereof, polyamine sulfone and the quaternary salts thereof, polyvinylamine and the quaternary salts thereof, chitosan and the acetates thereof, polymers of monomers selected from the group consisting of dimethylaminoethyl (meth)acrylate, diethylaminoethyl (meth)acrylate, methylethylaminoethyl(meth)acrylate, dimethylaminostyrene, diethylaminostyrene, copolymers of vinylpyrrolidone with a quaternary salt of an aminoalkyl (meth)acrylate and a copolymer of (meth)acrylamide with a quaternary salt of aminomethyl (meth)acrylamide.

9. The inkjet recording material as claimed in claim 1, characterized in that the cationic inorganic particles of the surface layer c) are selected from alumina, aluminum hydroxide, hydrated alumina, silica whose surface was cationized, aluminum silicates or other metalloid oxides.

10. The inkjet recording material as claimed in claim 1, characterized in that the cationic inorganic particles of the surface layer c) have a mean particle diameter in the range of 1-1000 nm.

11. The inkjet recording material as claimed in claim 1, characterized in that the surface layer c) additionally contains organic pigments comprising a thermoplastic resin.

12. The inkjet recording material as claimed in claim 1, characterized in that the surface layer c) has a coat weight (absolutely dry) of from 2 to 15 g/m².

13. The inkjet recording material as claimed in claim 1, characterized in that the gloss of the inkjet recording material is from 10 to 50, measured according to DIN 54502 R′ (45) (measuring angle 45°).

14. The inkjet recording material as claimed in claim 1, characterized in that the density of the inkjet recording material is greater than or equal to 1.00 g/cm³.

15. A process for the production of an inkjet recording material preferably as claimed in at least one of the abovementioned claims, comprising the steps:
a) provision of a substrate,
b) application of at least one ink-accepting layer to at least one side of the substrate, containing at least one pigment selected from the group consisting of calcium carbonate, calcined clay, satin white or mixtures thereof, the mean particle size of the pigment being from 0.1 μm to 1.5 μm,
c) application of at least one surface layer to the at least one ink-accepting layer, the surface layer containing cationic inorganic particles, and
d) optional calendaring of the inkjet recording material.

16. The process as claimed in claim 15, characterized in that the substrate in step a) is a paper or cardboard.

17. The process as claimed in claim 15, characterized in that the ink-accepting layer in step b) and/or surface layer in step c) are applied from an aqueous coating slip.

18. The process as claimed in claim 15, characterized in that a blade coater, an airbrush, a knife coater, an air knife, a slot nozzle and/or a curtain coater is used for applying the ink-accepting layer in step b) and/or surface layer in step c).

19. The process as claimed in claim 15, characterized in that the ink-accepting layer b) has a coat weight (absolutely dry) of from 5 to 30 g/m² after drying.

20. The process as claimed in claim 15, characterized in that the surface layer c) has a coat weight (absolutely dry) of from 2 to 15 g/m² after drying.

21. The process as claimed in claim 15, characterized in that the inkjet recording material has a gloss in the range from 10 to 60, measured according to DIN 54502 R′ (45°) (measuring angle 45°), on the side on which the at least one surface layer was applied, and the density of the inkjet recording material is greater than or equal to 0.95 g/cm³.

22. (canceled)
